(19) United States
(12) Patent Application Publication
(10) Pub. No.: US 2016/0101645 A1
(43) Pub. Date: Apr. 14, 2016

(54) COMBINATION ANTLER DISPLAY MOUNT

(71) Applicants: Tom Appel, Bristolville, OH (US); Jason Crisp, Bristolville, OH (US); Melissa Crisp, Bristolville, OH (US)

(72) Inventors: Tom Appel, Bristolville, OH (US); Jason Crisp, Bristolville, OH (US); Melissa Crisp, Bristolville, OH (US)

(21) Appl. No.: 14/510,393

(22) Filed: Oct. 9, 2014

(51) Int. Cl. B44C 5/02

(52) U.S. Cl. CPC B44C 5/02

(57) ABSTRACT

An antler display mount system for mounting of antler sheds and skull cap antlers on a single combination mount configuration. A decorative support and engagement background element depicts the natural habitat of the animal in a two-dimensional or three-dimensional metal cut-out to provide a unique and environmentally specific design to enhance the nature and character of the mount.

### BACKGROUND OF THE INVENTION

1. Technical Field

This invention relates to antler/trophy mounts in which the antler or horns of a sport animal are displayed.

2. Description of Prior Art

Prior art antler displays have relied on a variety of different mounting techniques including trophy antlers or horn mounts as seen for example in U.S. Pat. Nos. 453,008, 4,464,440, 4,717,626, 4,971,865 and 5,472,765.

U.S. Pat. No. 453,008 is directed to an animal horn display escutcheon having wall support plate with a horn restraint shield cover.

U.S. Pat. No. 4,464,440 illustrates a trophy mount for displaying horns and antlers having artificial animal head representations onto which the antlers are secured.

U.S. Pat. No. 4,971,865 claims an adjustable antler wall hanging bracket on which a deer skull with antlers attached is secured.

U.S. Pat. No. 5,472,765 discloses a shed antler mounting kit with a molded animal skull replication onto which “shed” antlers are attached having a base support plate.

### SUMMARY OF THE INVENTION

An antler mount that provides multiple mounting systems on a single display support surface that depicts natural scenic background specific to the animal's natural habitat. The mounting system accommodates both shed antlers and skull cap antlers without additional accessories. Integrated individual adjustable mounting tabs provide for unique antler positioning in accordance with the user's requirements. The skull cap mounting system adapts to cover the skull cap and provide uniform visual surfaces within a compression plate engagement assembly secured to the support surface scenic background depiction.

### DESCRIPTION OF THE DRAWINGS

FIG. 1 is a front elevational view of the antler display mount for a skull cap antler mount.

FIG. 2 is an enlarged partial front elevational view of an individual adjustable antler mounting tabs.

FIG. 3 is an enlarged partial front elevational view of the antler mounting tab completed mount.

FIG. 4 is an enlarged partial sectional view of the skull cap mount assembly.

FIG. 5 is an enlarged partial front elevational view of the completed skull cap antler mount.

FIG. 6 is a front plan view of a fabric skull cap adjustable cover used within the system for both shed antlers and skull cap antler mounts.

### DETAILED DESCRIPTION OF THE INVENTION

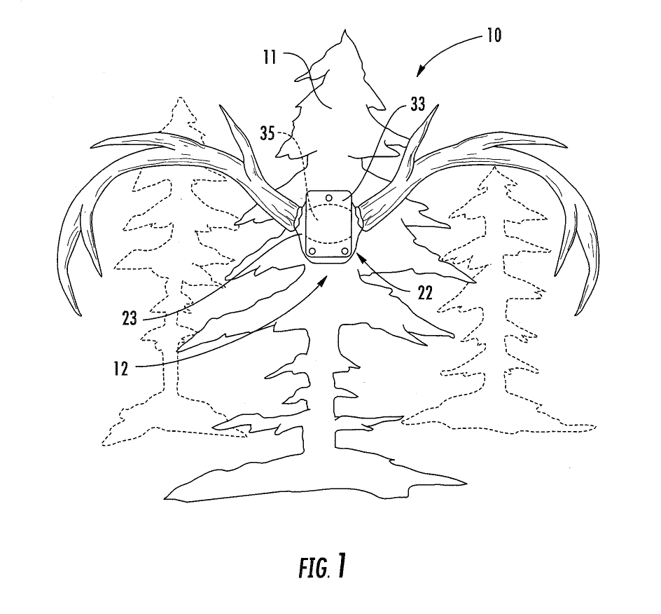

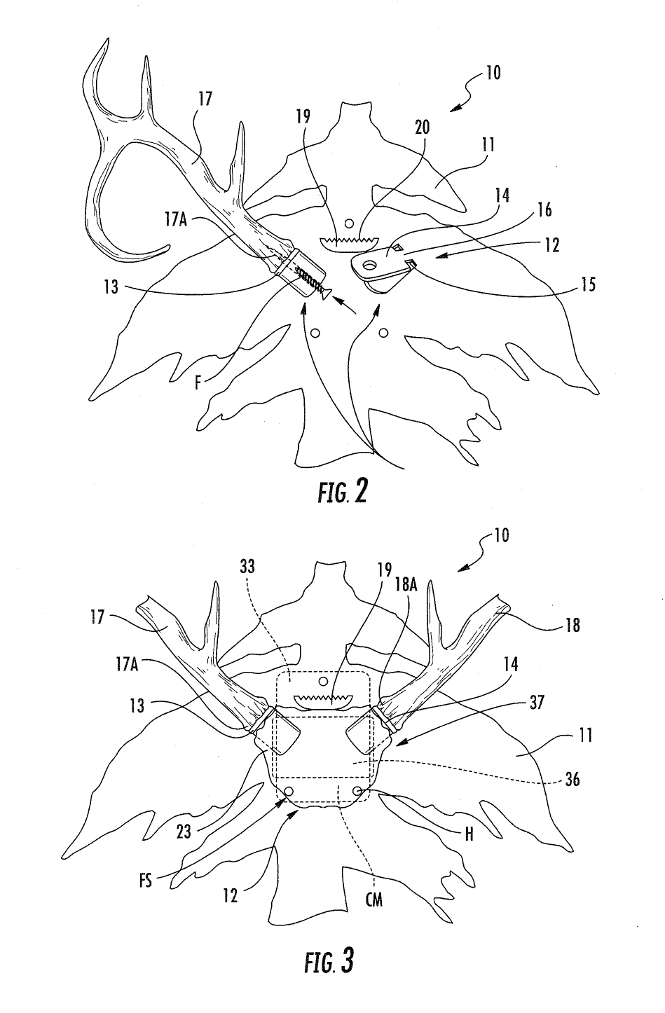

Referring to FIGS. 1 and 2 of the drawings, a combination antler display mount of the invention 10 can be seen having a decorative support and mounting plate 11 which depicts a specific natural habitat relative to the animal displayed. The decorative plate 11 is preferably of integrally cut metal with a central mounting area 12 therein.

Referring to FIG. 2 of the drawings, a pair of angularly disposed spaced shed antler mounting tabs 13 and 14 can be seen which are formed from within the central mounting area 12. Each of the mounting tabs 13 and 14 is of a rectangular configuration with a pair of transversely positioned spaced notches 15 therein adjacent to its distal attachment point at 16 with an antler mounting aperture A within the respective proximal surface areas. It will be seen that independent shed antlers 17 and 18, in this example, can be secured to the respective mounting tabs 13 and 14 by screw fasteners F extending through the aperture tab and into respective central base portions 17A and 18A of the shed antlers. Once so secured, each of the antlers can be independently repositioned in multiple dimensions by bending the respective mounting tabs 13 and 14 along their notch defined hinge attachment lines translaterally and in a variety of angular configurations to achieve a custom antler mounting position as will be described in detail hereinafter.

A hanger slot 19 can be seen within the mounting area 12 surface in spaced relation adjacent the respective mounting tabs 13 and 14. The hanger slot 19 has multiple teeth 20 formed in an upper engagement surface 21 to provide for multiple hanging support points to accommodate the uneven weights of the respective antlers, if required, on a vertical wall surface W illustrated in this example.

Referring now to FIGS. 1, 3, 4, 5 and 6 of the drawings, an antler skull cap mounting assembly 22 can be seen having a generally rectangular universal fabric skull wrap 23, best seen in FIG. 6 of the drawings with oppositely disposed inclusive elastic side edge trims 24 and 25 and a pair of Velcro enabled hook and loop material trim adjustment straps 26 and 27 extending respectively therefrom. An interengageable Velcro insert strip 28 secured inwardly along an upper edge 29 thereof and extends between straps 26 and 27 affording multiple points of selective engagement as will be discussed.

An oppositely disposed pair of spaced Velcro enabled (hook material) strips 30 and 31 are secured and extend inwardly from the bottom fabric edge 32 in spaced relation to one another so as to be engaged during use with the upper edge Velcro insert 28, noted above.

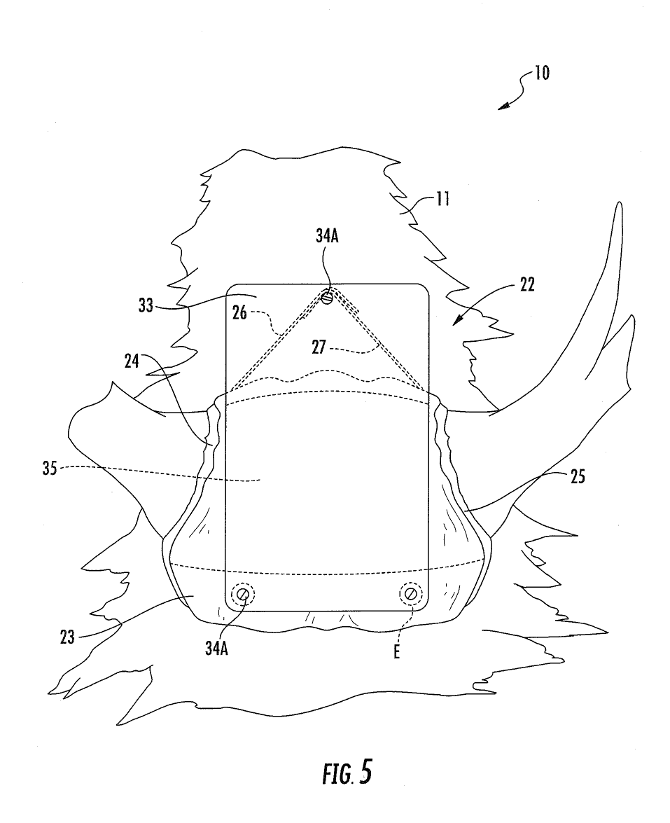

Pairs of vertically aligned spaced parallel skull wrap positioning holes H are formed within an upper field portion 23A of the fabric skull wrap 23. The holes H have reinforcement eyelets E thereabout and provide during use pairs of aligned pass through points for respective fastener assemblies FA as will be described hereinafter. The skull cap mounting assembly 22 as seen best in FIG. 4 of the drawings has an adjustable compression plate 33 of a rectangular dimension, in this example, with a plurality of mounting apertures A therewithin. The fastener assemblies FA adjustably secure the compression plate 33 to the decorative mounting plate 11 and comprise threaded bolts 34A and threaded tubular connectors 34B so as to extend through the compression plate mounting apertures A in registerable alignment with the multiple skull wrapped position holes H and corresponding apertures A in the decorative support and mounting plate 11 which are positioned adjacent the respective mounting tabs 13 and 14 as seen in FIG. 2 of the drawings.

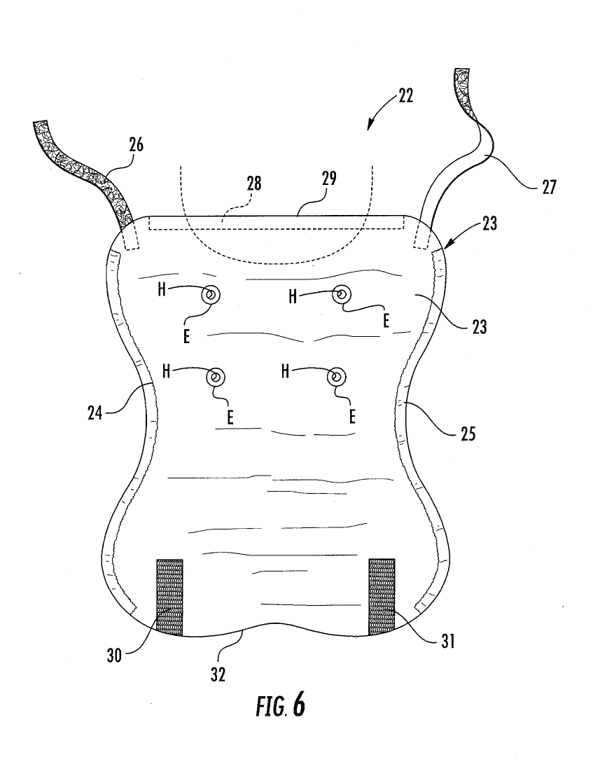

In use, an animal skull cap 35 illustrated graphically in broken lines in FIGS. 4 and 5 of the drawings with attached antlers is wrapped within the fabric skull wrap 23 having a foam cushion lining 23B wherein the Velcro strips 30 and 31 can be interengaged by pulling the wrap up over the skull cap onto the insert strip 28 for universal adjustable fit.

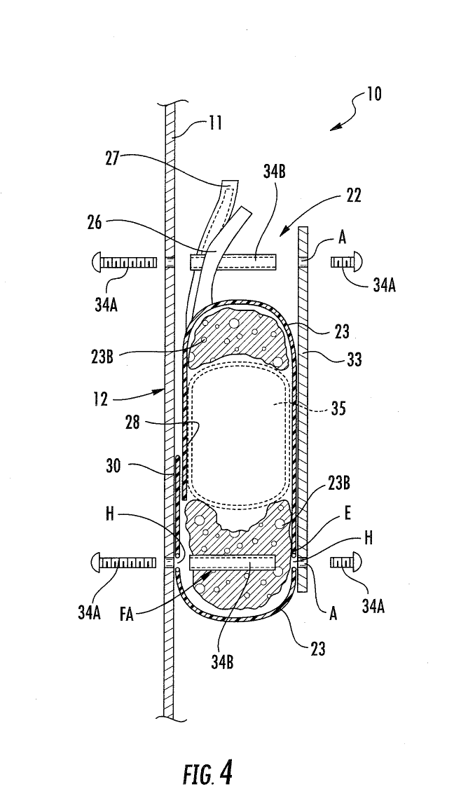

It will be seen that the skull wrap elastic side edge trims 24 and 25 will therefore form around the respective base of the antlers to provide a unique custom fit. The wrapped skull cap 25 with antlers protruding is positioned and held in place on the decorative support and mounting plate 11 surface 11A by engagement of the compression plate 33 thereover in which the multiple fastener assemblies FA are threadably engaged through the compression plate and the aligned holes H and therefore retained on the decorative mounting plate 11 as seen in FIG. 3 of the drawings. The trim tab adjustable straps 26 and 27 are then adjustably engaged to one another over the single fastener assembly FA′ allowing for final adjustment fitting of the wrapped animal skull cap 35 between the decorative mounting wall plate 11 and the compression plate 33.

The fabric skull wrap 23 can also be used to complete the mount of the hereinbefore described shed antlers 17 and 18 which, as noted, are adjustably mounted on the respective mounting tabs 13 and 14. The skull wrap 23, as best seen in FIG. 3 of the drawings, in this application has a correspondingly sized foam cushion material layer CM shown in broken lines and a block of semi-rigid filler foam 36 illustrated in dotted lines in FIGS. 3 and 6 of the drawings. The semi-rigid filler foam 36 is utilized as a spacer and filler and is placed on the foam cushion material CM and the skull wrap 23 is then “wrapped” therearound and held in place by the interengagement of the strips 30 and 31 to the corresponding insert attachment strip 28, as noted, forming a shed antler support mount assembly 37.

Once positioned on the decorative mounting plate 11 between the tabs 13 and 14 having the attached shed antler 17 and 18, the fastener assemblies FS which have positioned through and extend from the mounting plate 11 are correspondingly inserted through the gathered and aligned holes H pairs with the compression plate 11 secured thereover. The multiple fastener assemblies FS are then adjustably engaged against the compression plate 11 overlying the support and filler foam 36 between the tabs 13 and 14.

The corresponding assembly is then adjustable so as to conform about the respective antler basis by the trim tabs 26 and 27 extending about the remaining central fastener assembly as herein before described.

It will be evident from the above description that the utilization of the fabric skull wrap 23 in combination with the adjustable compression plate 33 provides, in essence, a universal mounting configuration for both the skull cap antler display and shed antler onto a decorative support mounting plate 11 which can selectively depict a specific scenic habitat environment related to the animal display. Additionally, with the utilization of multiple adjustable shed antler mounting tabs 13 and 14 independent shed antlers 17 and 18 can be affixed and then adjusted on the decorative mounting plate to emulate a specific antler orientation unique to the animal and provide the user a distinctive identifiable custom antler display mount in both configurations as hereinbefore described.

It will thus be seen that a unique and novel combination antler display mount has been illustrated and described and it will be apparent to those skilled in the art that various changes and modifications may be made thereto without departing from the spirit of the invention. Therefore I claim:

1. A combination antler display mount for displaying a wildlife object on a decorative wall display comprising,
a decorative wall plate, adapted for securing to a wall,
antler mounting tabs formed in said plate,
a flexible fabric skull wrap adapted for adjustably covering about a portion of the wildlife object,
a compression plate selectively secured to said decorative wall plate overlying a portion of the wildlife object,
means for securing said compression plate and said flexible fabric skull wrap about portions of the wildlife object to said wall plate.

2. The combination antler display mount set forth in claim 1 wherein said mounting tabs have apertures therein for receiving a screw fastener therethrough.

3. The combination antler display mount set forth in claim 1 wherein said mounting tabs are deformable from a first position in planar relation to said retainment plate to a second position in angularly disposed relation thereto.

4. The combination antler display mount set forth in claim 1 wherein said flexible fabric skull wrap has multiple attachment straps extending therefrom and selected interengaging surface attachment fasteners on said straps and said wrap.

5. The combination antler display mount set forth in claim 1 wherein means for securing said compression plate and said flexible fabric skull wrap about a portion of the wildlife object to said wall plate comprises,
fastener assemblies extending through aligned apertures in said compression plate and said flexible skull wrap and said decorative wall plate.

6. The combination antler display mount set forth in claim 1 wherein said fabric skull wrap further comprises,
oppositely disposed attached elastic side edges and padding about its interior surface.

7. The combination antler display mount set forth in claim 1 wherein said decorative wall plate is made of cut out metal in the shape of a natural environment.

8. The combination antler display mount set forth in claim 1 wherein said antler mounting tabs are in spaced aligned relation to one another.
